(19) United States
(12) Patent Application Publication
(10) Pub. No.: US 2024/0004492 A1
(43) Pub. Date: Jan. 4, 2024

(54) ELECTRONIC DEVICE

(71) Applicant: ASUSTeK COMPUTER INC., Taipei (TW)

(72) Inventors: Yao-Yu TSAI, Taipei (TW); Chien-Chih TSENG, Taipei (TW); Chun-Tsai YEH, Taipei (TW); Ya-Ting CHEN, Taipei (TW)

(21) Appl. No.: 18/180,255

(22) Filed: Mar. 8, 2023

(30) Foreign Application Priority Data
Jun. 29, 2022 (TW) 111124386

(51) Int. Cl. G06F 3/041; G06F 3/14; G06F 3/0488

(52) U.S. Cl. CPC G06F 3/0416; G06F 3/14; G06F 3/0488

(57) ABSTRACT

An electronic device includes a touch device, a display device, and a processor. The processor includes a built-in operating system with a user mode and a kernel mode. The user mode includes a touch application module, a control interface module, and an image application module. The kernel mode includes a main driver module and a secondary driver module. The secondary driver module performs preliminary behavior analysis processing on a sensing signal, and then transmits the sensing signal to the touch application module, to obtain corresponding touch data and transmit the touch data to the control interface module. The control interface module generates a display instruction according to the touch data. The image application module generates image data according to the display instruction. The main driver module receives and processes the image data to generate a display image, to directly transmit the display image to the display device.

### CROSS-REFERENCE TO RELATED APPLICATION

This application claims the priority benefit of Taiwan Application Serial No. 111124386, filed on Jun. 29, 2022. The entirety of the above-mentioned patent application is hereby incorporated by reference herein and made a part of the specification.

### BACKGROUND OF THE DISCLOSURE

### Field of the Invention

The disclosure relates to an electronic device with a touch function and image display.

### Description of the Related Art

Affected by global epidemic, conventional working methods and lifestyle in the past have been greatly changed. Especially for creative workers, future working modes are bound to be more open and free to choose suitable production tools to stimulate their own creativity and imagination and increase production efficiency. Most creators need a dial to increase use efficiency of an application (APP) required for creation. At present, products on the market are basically classified into two types of dial devices. One is a built-in dial, which is a built-in dial for a notebook computer, but the dial has no screen. The operation is less intuitive and lacks interaction. The other one is an external dial. A notebook computer is externally connected to a dial device through a USB and in other manners. Although many functions are included, it is inconvenient to carry and has high cost.

Moreover, at present, there is no built-in dial with touch operation in any notebook computer on the market. To achieve the objective, in a conventional method, a USB image is only converted into low-voltage differential signaling (LVDS) by a system through a micro-controller unit (MCU), and then the LVDS is converted into an embedded display port (eDP) image or a mobile industry processor interface (MIPI) image before being transmitted to a display panel. In this case, the display panel is regarded as a USB display device by the system. In addition to using the MCU, the display panel is regarded as the USB display device by the system, and the signaling conversion process is complex.

### BRIEF SUMMARY OF THE INVENTION

According to the first aspect of this disclosure, an electronic device is provided. The electronic device includes a touch device, a display device, and a processor. The touch device is configured to receive a touch gesture to generate a sensing signal. The processor is electrically connected to the touch device and the display device. The processor includes a built-in operating system, which includes a user mode and a kernel mode. The user mode includes a touch application module, a control interface module and an image application module, and the kernel mode includes a main driver module and a secondary driver module. The secondary driver module first performs preliminary behavior analysis processing on the sensing signal, and then transmits the sensing signal to the touch application module for calculation processing, to obtain corresponding touch data and transmit the touch data to the control interface module. The control interface module generates a corresponding display instruction according to the touch data. The image application module generates image data according to the display instruction. The main driver module receives and processes the image data to generate a display image, to directly transmit the display image to the display device.

According to the second aspect of this disclosure, an electronic device is provided. The electronic device includes a touch device, a display device, and a processor. The touch device is configured to receive a touch gesture to generate a sensing signal. The processor is electrically connected to the touch device and the display device. The processor includes a built-in operating system, which includes a user mode and a kernel mode. The user mode includes a control interface module and an image application module, and the kernel mode includes a main driver module and a secondary driver module. The secondary driver module performs calculation processing on the sensing signal to obtain corresponding touch data. The control interface module generates a corresponding display instruction according to the touch data. The image application module generates image data according to the display instruction. The main driver module receives and processes the image data to generate a display image, to directly transmit the display image to the display device.

In conclusion, the disclosure provides an electronic device, which uses a built-in operating system in a processor to process and control touch and display, so that the electronic device is directly used as a dial system with a touch function and image display, to achieve advantages of convenient carrying and low cost. In addition, the disclosure further has the following advantages: A display device in the operating system is not regarded as a screen device by the operating system, to avoid being interfered by the operating system to limit capabilities of setting and expansion; a more flexible interface is provided for a user to set freely; and in the disclosure, the operating system of the processor is directly used to control the functions of touch and display without support of an MCU.

### BRIEF DESCRIPTION OF THE DRAWINGS

FIG. 1 is a schematic block diagram of an electronic device according to an embodiment of the disclosure.

FIG. 2 is a schematic block diagram of an electronic device according to another embodiment of the disclosure.

FIG. 3 is a schematic block diagram of an electronic device according to still another embodiment of the disclosure.

FIG. 4 is a schematic block diagram of an electronic device according to yet another embodiment of the disclosure.

### DETAILED DESCRIPTION OF THE EMBODIMENTS

Exemplary embodiments are provided below for detailed description. However, the embodiments are only used as examples for description and do not limit the protection scope of the disclosure. In addition, some elements are omitted in the drawings in the embodiments, to clearly show technical features of the disclosure. The same reference numerals are used to indicate the same or similar elements in all of the drawings.

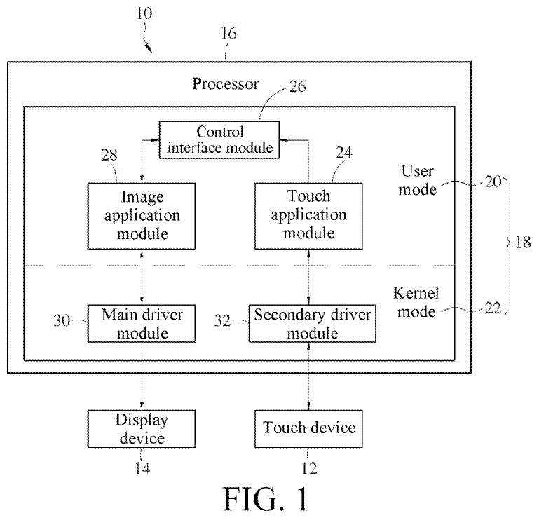

FIG. 1 is a schematic block diagram of an electronic device according to an embodiment of the disclosure. Referring to FIG. 1, the electronic device 10 includes a touch device 12, a display device 14, and a processor 16. The touch device 12 is configured to receive a touch gesture to generate a sensing signal. The processor 16 is electrically connected to the touch device 12 and the display device 14. The processor 16 receives the sensing signal from the touch device 12, and performs calculation processing on the sensing signal, to generate a corresponding display image and directly transmit the display image to the display device 14, so that the display device 14 directly displays the display image without any MCU.

In an embodiment, the electronic device 10 is a notebook computer, and the touch device 12 is a touch pad, a touch panel (touch screen), or any input device that supports touch input. In an embodiment, the display device 14 is a liquid crystal display (LCD) device, a light-emitting diode (LED) display device, or an organic light-emitting diode (OLED) display device.

In the electronic device 10, the disclosure further describes a basic architecture for a built-in operating system 18 to perform dial touch from a system architecture of the processor 16 of the electronic device 10. As shown in FIG. 1, the processor 16 includes the built-in operating system 18, which includes a user mode 20 and a kernel mode 22. The user mode 20 includes a touch application module 24, a control interface module 26, and an image application module 28, so that the touch application module 24, the control interface module 26 and the image application module 28 are run in the user mode 20. The kernel mode 22 includes a main driver module 30 and a secondary driver module 32, so that the main driver module 30 and the secondary driver module 32 are run in the kernel mode 22. The control interface module 26 is in signal connection to the touch application module 24 and the image application module 28, the touch application module 24 is in signal connection to the secondary driver module 32, the secondary driver module 32 is in signal connection to the touch device 12, the image application module 28 is in signal connection to the main driver module 30, and the main driver module 30 is in signal connection to the display device 14.

When a user performs a touch gesture on the touch device 12, the touch device 12 receives the touch gesture to generate a corresponding sensing signal and transmit the sensing signal to the secondary driver module 32. The secondary driver module 32 first performs preliminary behavior analysis processing on the sensing signal and then transmits the sensing signal to the touch application module 24 for calculation processing, to obtain corresponding touch data and transmit the touch data to the control interface module 26. The control interface module 26 is a control interface of the user mode 20 and provides a user interface for the user to operate. The control interface module 26 receives the touch data from the touch application module 24, generates a corresponding display instruction according to the touch data, and transmits the display instruction to the image application module 28. The image application module 28 generates corresponding image data according to the display instruction, and transmits the image data to the main driver module 30. After receiving the image data, the main driver module 30 performs image processing and generates a display image according to the image data. In this case, without using the MCU, the main driver module 30 directly transmits the display image to the display device 14, so that the display image is directly displayed on the display device 14, which enables the user to directly see the display image corresponding to the touch gesture on the display device 14, and enables the electronic device 10 (the touch device 12, the processor 16, and the display device 14) to be directly used as a dial system with a touch function and image display.

In an embodiment, the main driver module 30 directly transmits the display image to the display device 14 for display through a serial peripheral interface (SPI). In addition, the main driver module 30 transmits a control signal to the display device 14 through a general-purpose input/output (GPIO) interface. The control signal is used to control whether a backlight is to be turned on, starting of data transmission, and the like. Moreover, because there is no MCU between the display device 14 and the main driver module 30 in the operating system 18, in addition to cost, the operating system 18 is directly connected to the display device 14 through the SPI to directly transmit the image, and frame per second (FPS) is also faster.

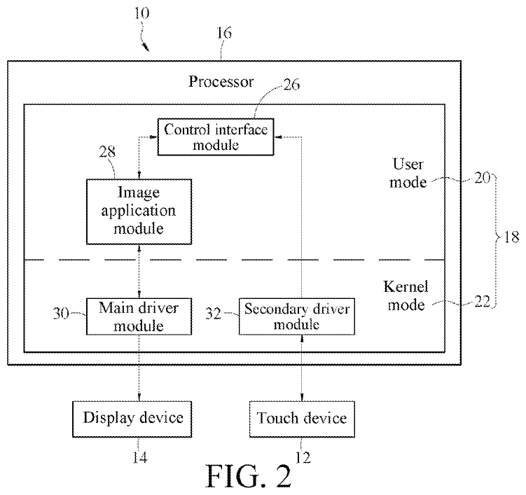

FIG. 2 is a schematic block diagram of an electronic device according to another embodiment of the disclosure. Referring to FIG. 2, in an operating system 18 of a processor 16, the operating system 18 includes a user mode 20 and a kernel mode 22. The user mode includes a control interface module 26 and an image application module 28, so that the control interface module 26 and the image application module 28 are run in the user mode 20. The kernel mode 22 includes a main driver module 30 and a secondary driver module 32, so that the main driver module 30 and the secondary driver module 32 are run in the kernel mode 22. The control interface module 26 is in signal connection to the secondary driver module 32 and the image application module 28, the secondary driver module 32 is in signal connection to a touch device 12, the image application module 28 is in signal connection to the main driver module 30, and the main driver module 30 is in signal connection to a display device 14.

As shown in FIG. 2, when a user performs a touch gesture on the touch device 12, the touch device 12 receives the touch gesture to generate a corresponding sensing signal, and transmits the sensing signal to the secondary driver module 32. The secondary driver module 32 first performs behavior mode calculation processing on the sensing signal to obtain corresponding touch data, and directly transmits the touch data to the control interface module 26. The control interface module 26 receives the touch data from the secondary driver module 32, generates a corresponding display instruction according to the touch data, and transmits the display instruction to the image application module 28. The image application module 28 generates corresponding image data according to the display instruction, and transmits the image data to the main driver module 30. After receiving the image data, the main driver module 30 performs image processing and generates a display image according to the image data. The main driver module 30 directly transmits the display image to the display device 14, so that the display image is directly displayed on the display device 14, which enables the user to directly see the display image corresponding to the touch gesture on the display device 14.

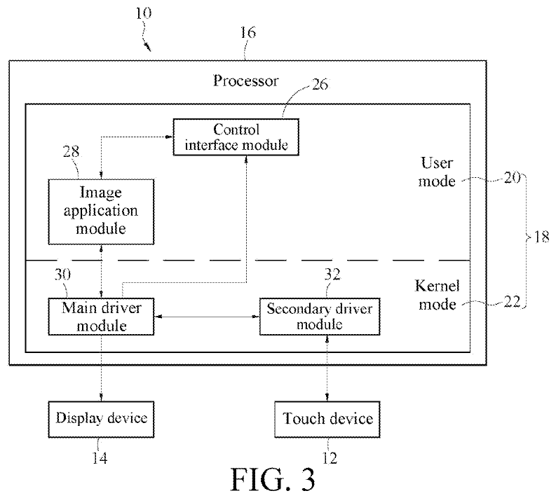

FIG. 3 is a schematic block diagram of an electronic device according to still another embodiment of the disclosure. Referring to FIG. 3, in an operating system 18 of a processor 16, the operating system 18 includes a user mode 20 and a kernel mode 22. The user mode 20 includes a control interface module 26 and an image application module 28, so that the control interface module 26 and the image application module 28 are run in the user mode 20. The kernel mode 22 includes a main driver module 30 and a secondary driver module 32, so that the main driver module 30 and the secondary driver module 32 are run in the kernel mode 22. The control interface module 26 is in signal connection to the image application module 28 and the main driver module 30, the secondary driver module 32 is in signal connection to the main driver module 30 and a touch device 12, the image application module 28 is in signal connection to the main driver module 30, and the main driver module 30 is in signal connection to a display device 14.

As shown in FIG. 3, when a user performs a touch gesture on the touch device 12, the touch device 12 receives the touch gesture to generate a corresponding sensing signal, and transmits the sensing signal to the secondary driver module 32. The secondary driver module 32 performs behavior mode calculation processing on the sensing signal to obtain corresponding touch data. The secondary driver module 32 first transmits the touch data to the main driver module 30, and then transmits the touch data to the control interface module 26 through the main driver module 30 to communicate with the control interface module 26 through the main driver module 30. The control interface module 26 receives the touch data from the main driver module 30, generates a corresponding display instruction according to the touch data, and transmits the display instruction to the image application module 28. The image application module 28 generates corresponding image data according to the display instruction, and transmits the image data to the main driver module 30. After receiving the image data, the main driver module 30 performs image processing and generates a display image according to the image data. The main driver module 30 directly transmits the display image to the display device 14, so that the display image is directly displayed on the display device 14, which enables the user to directly see the display image corresponding to the touch gesture on the display device 14.

In an embodiment, as shown in FIG. 1, FIG. 2, or FIG. 3, in the operating system 18, the main driver module 30 is a 3rd party driver. As shown in FIG. 1, FIG. 2, or FIG. 3, the secondary driver module 32 is a 3rd party driver or an inbox driver.

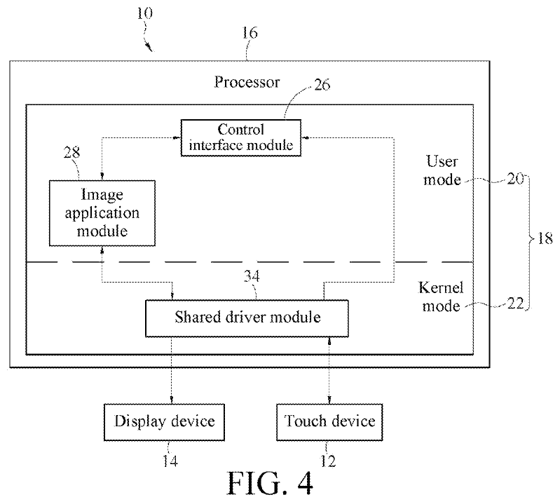

Moreover, in the disclosure, the main driver module 30 and the secondary driver module 32 are integrated into a shared driver module 34 to replace the functions of the main driver module 30 and the secondary driver module 32. Referring to FIG. 4, in an operating system 18 of a processor 16, the operating system 18 includes a user mode 20 and a kernel mode 22. The user mode 20 includes a control interface module 26 and an image application module 28, so that the control interface module 26 and the image application module 28 are run in the user mode 20. The kernel mode 22 includes a shared driver module 34, so that the shared driver module 34 are run in the kernel mode 22. The control interface module 26 is in signal connection to the image application module 28 and the shared driver module 34, the image application module 28 is in signal connection to the shared driver module 34, and the shared driver module 34 is in signal connection to a touch device 12 and a display device 14.

As shown in FIG. 4, when a user performs a touch gesture on the touch device 12, the touch device 12 receives the touch gesture to generate a corresponding sensing signal, and transmits the sensing signal to the shared driver module 34. The shared driver module 34 first performs behavior mode calculation processing on the sensing signal to obtain corresponding touch data, and transmits the touch data to the control interface module 26 to communicate with the control interface module 26 through the shared driver module 34. The control interface module 26 receives the touch data from the shared driver module 34, generates a corresponding display instruction according to the touch data, and transmits the display instruction to the image application module 28. The image application module 28 generates corresponding image data according to the display instruction, and transmits the image data to the shared driver module 34. After receiving the image data, the shared driver module 34 performs image processing and generates a display image according to the image data. In this case, without using an MCU, the shared driver module 34 directly transmits the display image to the display device 14, so that the display image is directly displayed on the display device 14, which enables the user to directly see the display image corresponding to the touch gesture on the display device 14.

In an embodiment, the shared driver module 34 directly transmits the display image to the display device 14 for display through an SPI. In addition, the shared driver module 34 transmits a control signal to the display device 14 through a GPIO interface. The control signal is used to control whether a backlight is to be turned on, starting of data transmission, or the like.

In an embodiment, as shown in FIG. 4, in the operating system 18, the shared driver module 34 is a 3rd party driver.

In an embodiment, as shown in FIG. 1 to FIG. 4, the modules run in the user mode 20 and the kernel mode 22 of the operating system 18, including the touch application module 24, the control interface module 26, the image application module 28, the main driver module 30, the secondary driver module 32 and the shared driver module 34, are separately implemented in a firmware or software manner, to operate normally in the operating system 18 and perform respective functions.

In conclusion, the disclosure provides an electronic device, which uses a built-in operating system in a processor to process and control touch and display, so that the electronic device is directly used as a dial system with a touch function and image display, to achieve advantages of convenient carrying and low cost. In addition, the disclosure further has the following advantages: A display device in the operating system is not regarded as a screen device by the operating system, to avoid being interfered by the operating system to limit capabilities of setting and expansion; a more flexible interface is provided for a user to set freely; and in the disclosure, the operating system of the processor is directly used to control the functions of touch and display without support of an MCU.

The embodiments described above are only used for describing the technical ideas and characteristics of the disclosure, and are intended to enable a person skilled in the art to understand and implement the content of the disclosure. However, the patent scope of the disclosure is not limited thereto. That is, any equivalent change or modification made according to the spirit disclosed in the disclosure still falls within the patent scope of the disclosure.

What is claimed is:

1. An electronic device, comprising:
a touch device, configured to receive a touch gesture to generate a sensing signal;
a display device; and
a processor, electrically connected to the touch device and the display device, and comprising a built-in operating system, wherein the operating system comprises a user mode and a kernel mode, the user mode comprises a touch application module, a control interface module and an image application module, and the kernel mode comprises a main driver module and a secondary driver module, wherein the secondary driver module first performs preliminary behavior analysis processing on the sensing signal, and then transmits the sensing signal to the touch application module for calculation processing, to obtain corresponding touch data and transmit the touch data to the control interface module, the control interface module generates a corresponding display instruction according to the touch data, the image application module generates image data according to the display instruction, and the main driver module receives and processes the image data to generate a display image, to directly transmit the display image to the display device.

2. The electronic device according to claim 1, wherein the control interface module provides a user interface for a user to operate.

3. The electronic device according to claim 1, wherein the main driver module is a 3rd party driver.

4. The electronic device according to claim 1, wherein the secondary driver module is a 3rd party driver or an inbox driver.

5. The electronic device according to claim 1, wherein the main driver module directly transmits the display image to the display device through a serial peripheral interface (SPI).

6. The electronic device according to claim 5, wherein the main driver module further transmits a control signal to the display device through a general-purpose input/output (GPIO) interface.

7. An electronic device, comprising:
a touch device, configured to receive a touch gesture to generate a sensing signal;
a display device; and
a processor, electrically connected to the touch device and the display device, and comprising a built-in operating system, wherein the operating system comprises a user mode and a kernel mode, the user mode comprises a control interface module and an image application module, and the kernel mode comprises a main driver module and a secondary driver module, wherein the secondary driver module performs calculation processing on the sensing signal to obtain corresponding touch data, the control interface module generates a corresponding display instruction according to the touch data, the image application module generates image data according to the display instruction, and the main driver module receives and processes the image data to generate a display image, to directly transmit the display image to the display device.

8. The electronic device according to claim 7, wherein the secondary driver module first transmits the touch data to the main driver module, and then transmits the touch data to the control interface module through the main driver module.

9. The electronic device according to claim 7, wherein the main driver module and the secondary driver module are integrated into a shared driver module to process the image data and the touch data separately.

10. The electronic device according to claim 9, wherein the shared driver module directly transmits the image data to the display device through an SPI.

11. The electronic device according to claim 10, wherein the shared driver module transmits a control signal to the display device through a GPIO interface.

12. The electronic device according to claim 7, wherein the control interface module provides a user interface for a user to operate.

13. The electronic device according to claim 7, wherein the main driver module is a 3rd party driver.

14. The electronic device according to claim 7, wherein the secondary driver module is a 3rd party driver or an inbox driver.

15. The electronic device according to claim 7, wherein the main driver module directly transmits the display image to the display device through an SPI.

16. The electronic device according to claim 15, wherein the main driver module transmits a control signal to the display device through a GPIO interface.
